(19) United States
(12) Patent Application Publication
(10) Pub. No.: US 2008/0309038 A1
(43) Pub. Date: Dec. 18, 2008

(54) Trash bag holder and transporter

(76) Inventor: James Gilligan, Northport, NY (US)

Correspondence Address: Law Office of Leo G. Lenna, 1 Makamah Beach Road, Northport, NY, 11768, US

(21) Appl. No.: 11/818,255

(22) Filed: Jun. 14, 2007

(51) Int. Cl. B62B 1/22

(52) U.S. Cl. 280/47.24

(57) ABSTRACT

The present invention is a bag holder/transport apparatus for plastic trash bags for use outdoors and indoors. A rim means is provided with a frame, a foot peg for pushing the end of the rim into the ground and an adjustable clamp assembly for attaching a trash bag positioned in the rim. An elongated strip of rigid material such as metal or plastic attached from the rim to the wheel base so as to support the trash bag is also provided so that the device can be used to wheel a filled bag to a disposal point after filling.

### FIELD OF THE INVENTION

The present invention relates generally to the field of trash and lawn bag holders and more particularly to a trash and lawn debris bag holder system that when in the horizontal position can be secured in place and when partially filled can be moved to an upright position and wheeled to a place for removal and disposal of the filled bag.

### BACKGROUND OF THE INVENTION

Yard waste removal has long been an endless weekend task completed by homeowners all over the world. In many municipalities, yard waste, such as leaves and grass clippings, is considered to be recyclable material and is therefore directed to compost facilities. These municipalities will dispose of yard waste separately than normal trash for recycling. As such, the yard waste is typically required to be stored in special waste collection bags for pickup. However, other municipalities only require the use of plastic bags for holding this yard waste. Hardware, grocery and convenience stores generally sell either paper or plastic yard waste collection bags that are compliant with the regulations governing such disposal and recycling of yard waste.

When using these yard waste collection bags, several problems and annoyances are obvious. The paper bags are difficult to initially open and to then hold open while filling, and plastic bags are difficult to hold open in a supported position so as to allow for easy insertion of the yard or garbage waste.

There are many existing apparatuses for aiding in the use of waste collection bags. The prior art devices generally fall into two categories; the first is a group of devices used to ease opening of either paper or plastic bags and consequently aid in holding them open. U.S. Pat. No. 6,155,522 discloses a yard debris collecting system utilizing a pivoted frame, a chute couplable to the frame and a collection bag couplable to the frame such the chute extends into and opens into the open bag. However, the frame of the '522 patent would prevent easy removal of the frame from the interior of the bag when the bag is full of trash or yard waste.

The frame is further provided with bent feet, which would also prevent the easy removal of the device from inside the bag. U.S. Pat. Nos. 5,292,093; 5,129,609; and 4,037,778, and Publication No. U.S. 2004/0026578 all show the use of accordion style cardboard or hard plastic inserts which can be placed into either paper or plastic waste collection bags and then be unfolded to assist in opening the bags. The inserts are sufficiently rigid to hold the waste collection bags upright for easy filling. For example, the bag insert of the King et al. Publication set forth above describes an accordian style insert which can be inserted into a paper yard waste bag to expand the bag and maintain it in an upright and open position. Once installed, the yard waste can now be inserted into the bag by dropping the waste through the open top of the bag insert.

After waste collection is complete, the bag insert is capable of being folded along several axes such that the size of the bag insert is reduced for storage. The other three issued patents listed above all show similar expandable inserts for use with plastic yard or garbage waste bags which can be unfolded to expand the plastic bag and hold the bag in the open position for filling with yard waste or garbage waste. However, each has to be removed from the interior of the bag it is inserted in after the bag is filled, a task which is messy and difficult to achieve, especially with plastic bags that tend to rip or tear during the task. When removed from the bag, the inserts can be folded up for storage.

The second group of patents relate to devices that hold one end of a plastic yard waste bag open such that the bag can be placed on its side in an open position to allow for filling with yard waste. U.S. Pat. Nos. 5,107,666; 5,106,041; 4,832,292; and 3,934,803 all show devices which can be used in this fashion. For example, the Paulus, Jr. reference (U.S. Pat. No. 3,934,803) shows a bag supporting device for holding a plastic yard waste bag with its receiving end in an open position essentially perpendicular to a horizontal surface to permit leaves and trash to be raked or swept into the interior of the bag. In some cases these devices are provided with integral scoops to allow for easy access to the bag. However, once the bag is filled the user is still left to struggle with the filled bag in order to get it to the sidewalk for disposal. In addition, many of these holders lack a securing system to hold the waste bag to the device and/or to hold the device from sliding when being filled with debris. In the patents that provide a securing device to prevent the device from moving while the bag is filled, these can only be used on soft surfaces such as a lawn since the spikes used to secure the device from moving would not penetrate a hard surface without damaging the surface.

While these devices may fulfill their respective, particular objectives and requirements, the above-mentioned patents have many shortcomings and are only limited in their use. In particular, the above discussed patents do not disclose a new yard waste collection system that can be used with both paper and plastic yard waste bags that is designed to hold open such bags, secures the bags in place when laid in the vertical position and can be wheeled away once manipulated to the upright position. Additionally, these features are not taught together with a novel plastic bag clip mechanism which easily secures the plastic bag against the frame of the yard waste collection device so as to prevent slippage of the plastic bag out of the device.

The present invention as described below teaches such a device and overcomes the shortcomings of the prior art references discussed above.

### SUMMARY OF THE INVENTION

The trash bag holding device of the present invention comprises a rim means for holding a bag in an open position. The rim can be made from a semi-rigid or rigid material in a substantially circular form. In alternative embodiments the rim can be in the form of a half circle, oblong with one flat side, triangle, or a rectangle. The trash bag holder of the present invention further comprises a clamping means that can be either stationary or movably attached to the rim means that is configured for securely holding a trash bag to the rim means.

The trash bag holding device of the present invention may further comprise a frame connected to the rim means at one end and to a wheelbase at the opposite end. The wheelbase comprising at least one wheel and can be used for aiding in the transportation of a filled or partially filled bag from one place to another. The trash bag holding device further comprises an anti slip means attached to the rim means for preventing the trash bag holding device from sliding when the rim means is place on the ground. The rim means can have retractable spikes that insert into the lawn when in the extended position and retract back into the device when in the transportation mold so as to prevent injury. In addition, the trash bag holding device of the present invention may further comprise an anti-slip gripping system that can be used on a hard surface like a driveway where the spikes would not be used in order to prevent the device from slipping.

The present invention and its features are discussed in more detailed using the figures provided in the detailed description section of this document.

### BRIEF DESCRIPTION OF THE DRAWINGS

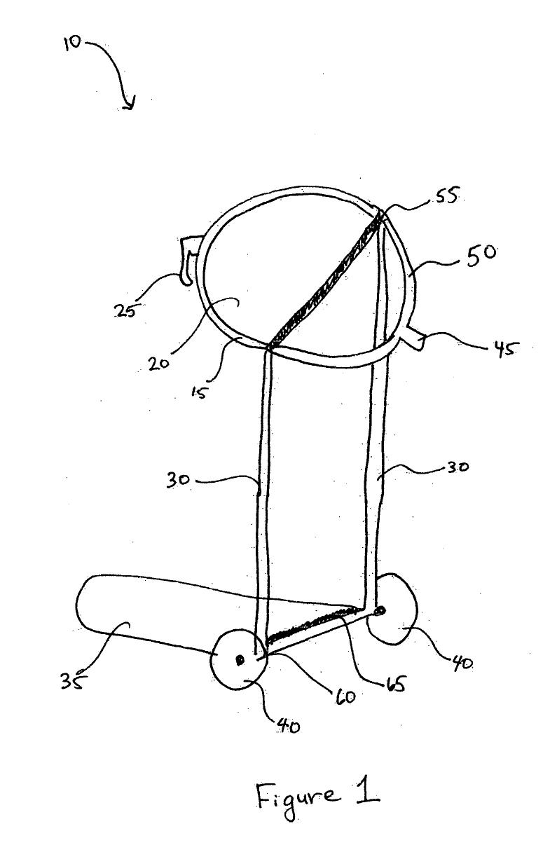

FIG. 1 is a side view of the trash bag holder and transporter of the present invention with the handle positioned to push the cart and the griping extensions in the retracted position.
10) Trash Bag Holder
15) Rim
20) Void
25) Trash Bag Locking Means
30) Supports
35) Trash Bag Support
40) Wheels
45) Handle
50) Push Bar
55) Hinge Means
60) wheel base

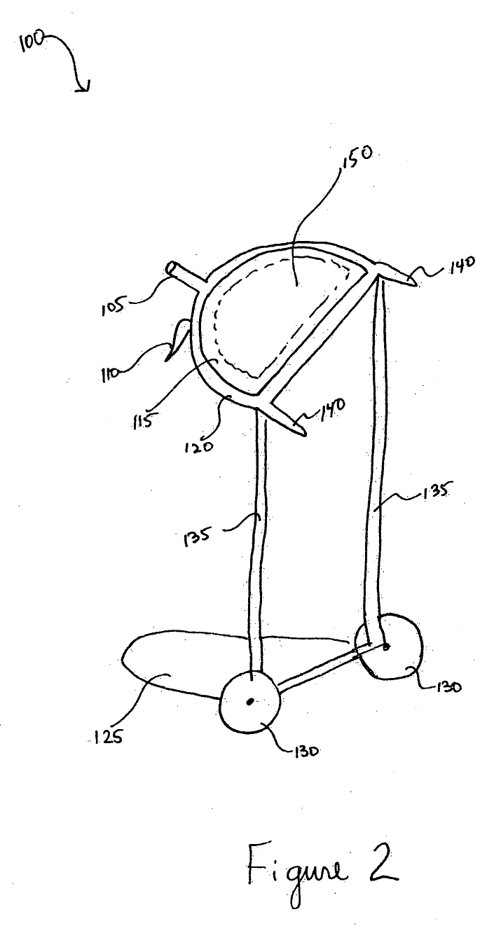

FIG. 2 is a side view of the trash bag holder and transporter of the present invention with the handle positioned to push the extended griping extensions into the lawn.
100) Trash Bag Holder with Extensions Tabs
105) Handle
110) Trash Bag Laching Means
115) Rim
120) Pushbar
125) Trash Bag Support
130) Wheels
135) Support
140) Griping Means
145) Hinge Means
150) Void

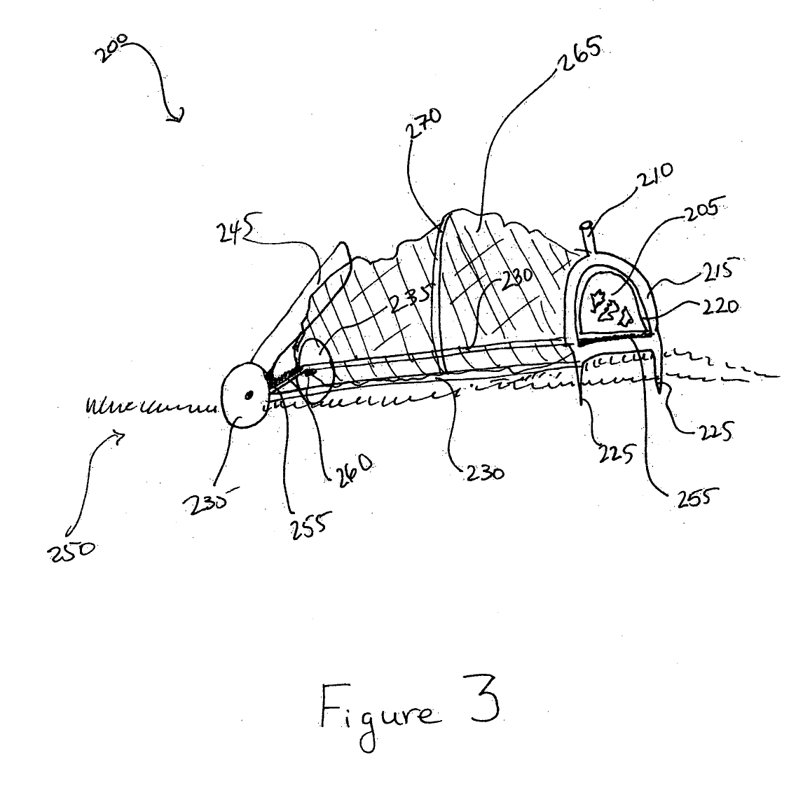

FIG. 3 is a side view of the trash bag holder and transporter of the present invention with the extended griping extensions embedded into the lawn.
(200) Trash Bag Holder with Extensions Tabs
(205) Void
(210) Handle
(215) Push bar
(220) Rim means
(225) Extension tabs
(230) Support means
(235) Wheels
(240) Wheel base
(245) Trash bag support means
(250) Lawn
(255) Hinge means

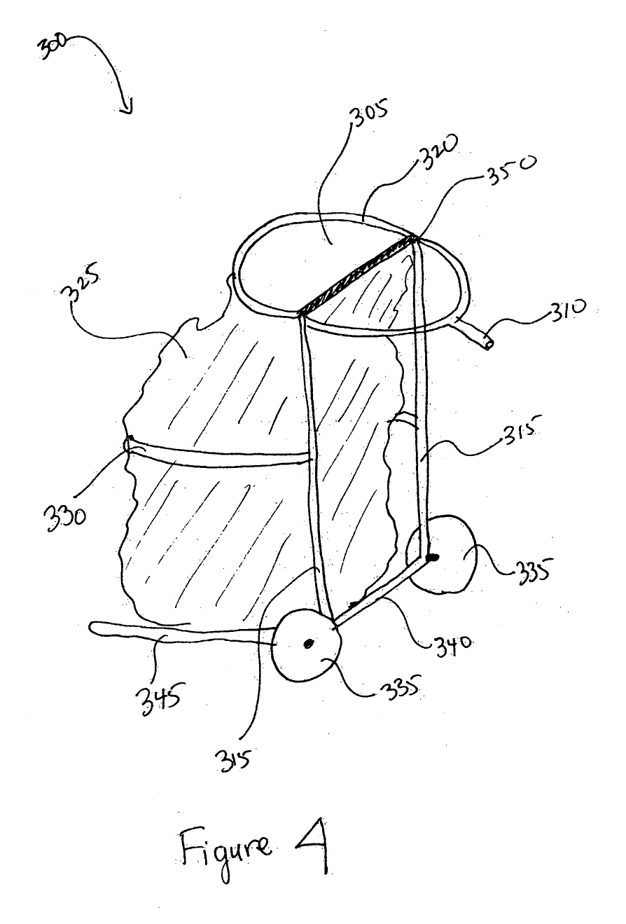

FIG. 4 is a side view of the trash bag holder and transporter of the present invention with a filled trash bag attached in the up righted position.
(300) Trash Bag Holder with Extensions Tabs retracted
(305) Void
(310) Handle
(315) Support Means
(320) Rim means
(325) Filled Trash Bag
(330) Tethering device
(335) Wheels
(340) Wheel base
(345) Trash bag support means
(350) Hinge means

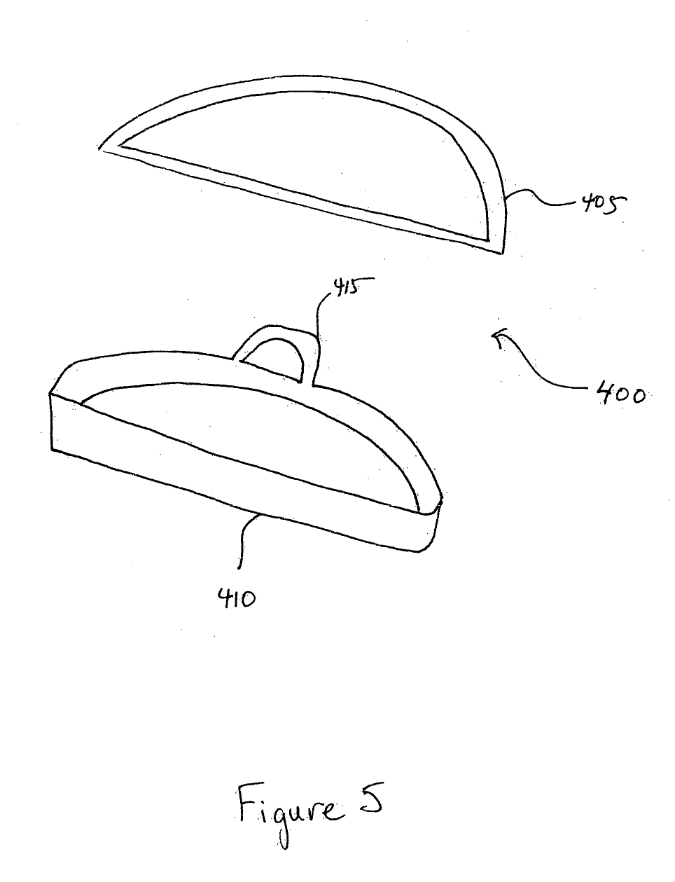

FIG. 5 shows a side view of one embodiment of the rim means assembly of the present invention.
(400) rim means assembly
(405) first section of rim means assembly
(410) second section of rim means assembly
(415) handle

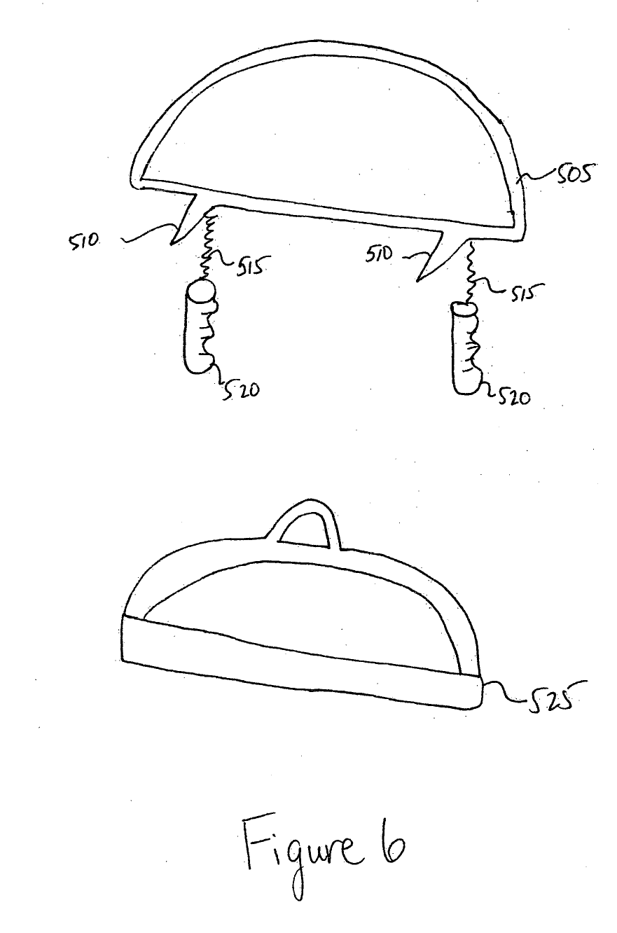

FIG. 6 shows a side view of one embodiment of the rim means assembly comprising spikes and grips of the present invention.
(500) rim means assembly
(505) first section of rim means assembly
(510) spike
(515) elastic attachment means
(520) grip
(525) second section of rim means assembly

### DETAILED DESCRIPTIONS OF THE INVENTION

The present invention is directed to a trash bag holder and transporter. In particular, the present invention is directed to a device that can be used to secure a trash bag in an open position so that debris i.e. leaves, can be raked into the open bag. One object of the present invention is a trash bag holder constructed so that it can be manipulated from a horizontal position in which the opening of the trash bag is adjacent to the lawn to allow leaves to effortlessly be raked into the trash bag and when the trash bag is almost filled the device can be manipulated into the upright position. In the upright position with the filled trash bag secured to the rim of the device in the open position, the remainder of the trash bag can be filled. When the trash bag is completely filled, the trash bag can be released from the rim of the device and tied shut.

Another object of the device is to be configured in such a way so that when the trash bag is released from the rim of the device, it can be tied and remain associated with the device. The device of the present invention can be equipped with wheels which would make transporting the filled, tied, trash bag that is ready for disposal, easy to transport to the curb for garbage pick-up.

Still another object of the trash bag holding/transporting device of the presented invention is to provide a gripping system designed to prevent the device from creeping away from a user as leaves are raked into the open trash bag. Since the device may be equipped with wheels, the device is prone to creeping away from the user as leaves are pushed into the open mouth of the trash bag. Similarly, the device may also slide away from the user if the device is perched on an incline while being used. Another object of the present invention is to be equipped with a griping system that can be used on both hard and soft surfaces. For example, the griping system should be able to be used to prevent creeping away from the user when the device is used on the black top of a driveway as well as when the device is used on the lawn.

Still yet another object of the device is to contain a trash bag securing means that is able to secure the trash bag to the rim of the device firmly enough so as not to be released when locked down, but not so firmly held that the trash bag tears as it is filled.

These and other objectives are realized by the trash holding/transporting device of the present invention as well as being easy to use, easy to store, and versatile enough to be used for any project that requires disposal of debris in a trash bag. The present invention is further described below and in the figures of the present invention.

In one embodiment of the present invention the trash bag holding and transportation device comprises a rim means for holding a bag in an open position. The rim means can be as simple as a series of clips cushioned so as to allow them to firmly press the trash bag against the rim of the device without tearing the bag. In one embodiment of the present invention the rim is in the shape of a halve circle with the flat portion configured to contour a flat surface in which it can be used. In the alternative the rim can be made of a moldable material that is firm enough to secure the trash bag in the open position, but moldable enough that it can conform to uneven surface.

In yet another embodiment the rim can be adjustable to different sizes in order to accommodate different size trash bags. For example, if the device is being used to hold open a construction trash bag that is usually smaller in diameter than a leaf bag, the rim can be adjusted so as to fit the construction trash bag and then readjusted to fit a leaf bag when the device is used to pickup leaves.

The device may also be equipped with a clamping means that is movably attached to the rim means of the device. The clamping means can be configured so that securing the trash bag is done uniformly around the rim means. Uniformly securing the trash bag to the rim always the grip on the trash bag to be distributed over the entire circumference of the bag, and therefore making it less likely for the trash bag to tear in any one given point. In one embodiment of the present invention, the clamping means further comprises a spring strip having a central portion configured in a substantially circular shape wherein the spring strip is compressed to permit an open end of a trash bag to be placed there over.

Once the trash bag holding system is in position the spring strip can be released to cause the open end of the trash bag to be secured to the trash bag holder and the trash bag is locked in place by a releasable locking means for locking the spring strip in a first position. The locking means can be adjusted to a second position which releases the trash bag from said clamping means so as to allow for the trash bag to be removed and disposed properly

The device may also be equipped with a frame connected to the rim means of the device at one end and a wheel base at the opposite end. The frame can be as simple as a single support bar attached to the rim means at one point by a connecting means and connected to a wheel base at the other end. The frame is designed to support the weight of full bag of debris, but not designed so bulky as to added unnecessary weight to the device. The frame can be made of stainless steel, aluminum, alloy, plastic, polyvinylchloride (PVC), polyurethane resins, nylon spun resin material, such as, fiberglass, man-made materials, powder coated steel or any other material that is economical, durable, and the lighter the better.

The wheel base of the device comprises at least one wheel and is used for transporting the trash bag holding device from one place to another. The wheelbase can be constructed to have two wheels connected by an axle and the axle can be connected to the frame. The wheels can be fixed to the axle in one orientation so that the device can be used in the same manner as a wheel truck.

The device may be further equipped with an anti-slip means for preventing the device from moving while it is being used can be attached to the device. In one embodiment the anti-slip means is attached to the rim means and can be as simple as a rough surface designed to increase friction on a surface so as to prevent sliding. In the alternative the anti-slip means can be small spikes that can be pushed into the ground to prevent the device from moving. The spikes can be attached to the rim by a rim and in the retracted position have anti-slip material, such as rubber or particulate paint the side of the spikes that will impact the ground when in the folded position. This allows the folded spikes to act as a griping mechanism to prevent the device from creeping when used on a hard surface like a driveway.

In one embodiment of the present invention, the spikes retract into a portion of the rim means so as to prevent the spikes form injuring the user when not in use. Once retracted, at least a portion of the rim means can be coated or covered with an anti-grip material that prevents the device from slipping on a hard surface. Alternate embodiments of the grip means of the present invention envisioned by one skilled in the art are also part of the invention.

The present invention is now described in connection with FIG. 1. FIG. 1 shows a schematic profile view of the trash bag holder of the present invention (10) in the upright position. This embodiment is shown with a wheelbase (60) having two wheels (40) but the trash bag holder of the present invention can be envisioned with one wheel or multiple wheels and even without a wheelbase at all. In the event that the embodiment is configured without a wheelbase at all, the device will have a blunt end (not shown) that the device rests on when in the upright position.

At the other side of the trash bag holder (1) is a rim means (15) that can have any shape. In a preferred embodiment of the present invention the trash bag holder (10) has a semi-circular shape so that when placed on the ground the substantially flat portion of the semi-circular shape is substantially flushed with the ground. In one preferred embodiment of the present invention, the substantially flat side of the rim means (15) is one the same side of the invention as the wheelbase (60). The rim means (15) produces a void (20) that is large enough for a trash bag positioned around the rime means (15) to be held open so that debris can be either raked or deposited into the open trash bag.

The rim means (15) is attached to the wheelbase (60) by a frame support means (30). The frame support means (30) can consist of one, two or more substantially straight support polls or a solid frame. The frame support means can either be fixed in length or adjustable in length. One embodiment of the invention can have adjustable frame support means that are designed to telescope in and out from each other so as to provide varying heights of the device but also to provide a convenient way of storing the device. Once a desired height or storage position is achieved, the telescoping poles can be locked into place using either a hole and pin or tension locking system that is well known in the art. Alternative locking means can be used and will not take away the inventive concept of the present invention.

One benefit that can be realized by having a telescoping frame is that the telescoping poles can be telescoped to be less than the full size wherein the rim means (15) is brought closer to the wheelbase (60) drastically reducing the overall storage height. This allows the device to be stored easily in the garage or shed when not in use.

Attached to the wheelbase (60) and projection outwardly is a trash bag support means (35) designed to support a filled or partially filled trash bag when the device (10) is in the upright position as shown in FIG. 1. The trash bag support means (35) can be attached to the frame support means (30) or the wheelbase (60) and can be designed so as to fold up when not in use for easy storage.

In one embodiment of the present invention, the rim means (15) is equipped with a trash bag locking means (25) that is designed to gently but firmly press the trash bag to the rim means (15) in the open position securely but without tarring the plastic bag. In other words, the locking means (250 is designed without sharp or piercing edges so as to secure the bag to the rim without compromising the integrity of the plastic bag. Doing so would cause the plastic bag to continue to tear and result in the contents of the bag either falling out placing the user back to where he or she started. Therefore, cushioned bushings, such as felt pads, must be used in order to avoid such problems. A spring loaded locking means can be used in order to secure the trash bag to the rim means and once the trash bag is filled, the trash bag locking means (250 can be released so as to allow the trash bag to be tied and wheeled to the curb for trash disposal.

The rim means (15) may also be equipped with a hinge means (55) positioned at the substantially flat portion of the device that attaches a push bar (50) to the device. The push bar (50) attached to the rim means (15) by hinge means (55) can be positioned in at least two positions. In the first position the push bar (5) is extended furthest away from the rim means and locks into place. Once locked into place, the push bar can be used by the user to push the device, either with a filled trash bag or not, on the wheels (40). The push bar can be further equipped with a handle (45) that allows the user to hold the push bar with one hand to maneuver the device to the desired location. Once in the desired location the push bar (50) can be unlocked and turned on the hinge means (55) to lay flush with the rim means (150) and be out of the way. In one embodiment, the push bar (50) is used as part of the trash bag locking means (25).

The trash bag holder (10) shown in FIG. 1 can be used in both the horizontal and upright position. In the horizontal position, the device (10) having a trash bag secured by the trash bag locking means (25) to the rim means (15) in the open position can be laid down on a lawn so that leaves can be raked into the void (20) of the trash bag opening. The device can be laid down on the substantially flat portion of the rim means so as to lay close to the lawn making raking the leaves into the bag easy. Once the bag is at least half filled the device can be up righted so that the filled bag rest on the trash bag support (35). The trash bag can be released from the trash bag locking means (25) and tied. The push bar (50) can be moved about the hinge means (55) so that the device (10) can be pushed about on the wheels (40) of wheel base (60).

In the alternative the trash bag can remain attached to the rim means (15) until the bag is filled and then removed from the rim by releasing the locking means (25). Once positioned on the trash bag support, the trash bag can be wheeled to either a storage place or to the curb for disposal.

FIG. 2 shows a schematic profile of the trash bag holder (100) of the present invention in an up righted position with the push bar (120) in the inoperative position and the grasping extensions (140) extended out from the substantially flat portion of the rim means (115). The griping extensions shown in FIG. 2 are in the shape of small spikes designed to embed into a soft surface such as a lawn when the trash bag holding device (115) is laid flat on a lawn. Although the spikes will penetrate into the lawn because of the weight of the device (115), to assure a proper grip the device may be shoved into the lawn.

With a trash bag secured to the rim means (115) and the push bar (120) in the closed position with the spikes extended, the device (100) of the present invention is ready to be positioned on a lawn. If the user desires to fill the trash bag while it remains in the up righted position, the push bar (120) should remain extended in the locked position so as retract the spikes and protect the user from harm. When the push bar (115) is rotated about the hinge means (145) into the extended the position, the spikes are retracted, the handle (105) is positioned on the same side of the wheels (130) and the device can be pushed using the push bar (115).

As the trash bag remains attached to the rim means (115), the weight of which is supported by the support means (135), it can be moved to the next position and either used in the up righted position or laid down on the lawn so that leaves can be raked into void (150) into the trash bag.

FIG. 3 shows a schematic profile view of the trash bag holder with a trash bag attached, the push bar (215) closed against the rim means (220) and the extensions tabs (225) extended into the lawn (250). The rim means (220) can be stepped on or otherwise shoved towards the lawn (250) so as to further embed the extension tabs (225) into the lawn (250) to prevent the trash bag holder (200) from creeping as leaves are raked into the trash bag. Once the device is in position on the lawn, debris can be raked and/or swept into the trash bag until it is filled. Once it is filled the handle (210) on the push bar (215) can be used to pull the extension tabs (225) out of the lawn (250) so that the trash bag holder (200) can be up righted. The support means (230) pivots about the wheels (235) until it up righted.

Once up righted the push bar (215) is pivoted about the hinge means (255) and the extension tabs (225) are retracted. In the alternative, the push bar (215) can be moved so while being up righted so that when the trash bag holder (200) reaches the up righted position the extension tabs (225) are already in the retracted position.

FIG. 4 shows the trash bag holder of the present invention (300) in the up righted position with a filled trash bag positioned on the trash bag support (345) and optionally held in place by a tethering means (330) which is attached to the support means (315) and can be stretched around the trash bag (325). The tethering means (330) can be faceted prior to lifting the trash bag (325) and the trash bag holding means (300) to the upright position.

In another embodiment of the present invention, the rim means 400 is designed in two interlocking pieces. As shown in FIG. 5, the first section 405 is part of the trash bag holding device and has a solid rim void of sharp edges. The second section 410 is removable and fits within the first section 405. Both the first and second sections of the rim means has a relatively flat smooth inner surface so that when a plastic bag is placed over the rim of the first section 405 of the rim assembly 400 it will not tear and/or rip the plastic bag. The second section 410 of the two-part rim means system 400 of the device is not attached to the device but is designed so that it can be fit snuggly within the inside portion of the first section 405. As with the first section 405 of the rim system means 400, the surfaces should be flat and relatively smooth so as not to tear or rip the plastic bag when it comes in contact with the bag. The second section 410 of the rim means system 400 can be flared inwards or crafted to be straight down, but regardless of the shape this piece of the rim means system must be designed to mate with the first section 405 of the system so as to temporarily interlock and hold the plastic bag in place.

The rim means system 400 is designed to compress the trash bag against each of the two mating surfaces of the rim means system 400 so as to hold the bag in the open position and prevent the bag from slipping out of the device once debris is placed into the bag. That is, the two-section rim means system 400 is designed to “sandwich” the plastic trash bag within the two locking pieces so as to hold the bag in place. Once the bag is filled and the device is wheeled to the curb to allow for proper disposal of the attached filled plastic garbage bag, the second piece 405 e.g., the inner portion of the rim means system, can be removed and the plastic bag allowed to fall out of the rim means system 400 so that the plastic bag can be tied. The second section 405 of the interlocking rim means system of the device can be configured to have a handle 415 opposite the flat portion of the rim means system that can be used to steer the device and aid in removing the second section 410 the rim system 400 when the bag is to be released. It is important that the handle 415 located on the second section of the rim means system 400 be designed so as to not interfere with the temporary interlocking of the first and the second sections 405 and 410 of the rim means system 400 of the device.

This alternative embodiment, requires no moving parts, such as springs and levers as described in other embodiments of the present invention, and therefore is more economical to produce and possibly easier to use. The two section rim means system 400 can be made from the same material as the rest of the device, including but not limited to resin, Poly Vinyl Chloride (PVC), manmade materials, plastics, rubber composites and the like. Regardless of what material is used to make the rim means system 400, the rim means system 400, as well as the rest of the device, should be constructed out of a material that is sturdy and can be easily washed with a garden hose should it be necessary to clean.

In still yet another embodiment of the present invention, the trash bag holder and transporter can be equipped with at least one lawn spike as shown in FIG. 6 which can be covered by grips 520 that also function as handles for transporting the device around. These grips 520 would serve to protect the user from injury when the spikes 510 are removed from the ground by fitting the grips 520 over the spikes 510 and covering the spikes so as to avoid injury. The grips 520 can be designed to automatically cover the spikes 510 as the spikes 510 are removed from the lawn and the device moved to the upright position. These grips 520 can be attached to the device by an elastic material 515 that when pull straight out retracts back to cover the spikes 510. The force created by the tension in the stretched elastic material 515 assures that the grips 520 remain on the spikes 510 and do not fall off in transport. When the spikes 510 are to be removed so that they can be inserted into the ground, the user can simply pull against the resistance of the elastic 515 and stretch the elastic 515 until the grips 520 are clear of the spikes 510 so that the spikes 510 can be made available to be inserted into the ground and prevent the device from creeping when used in the horizontal position. This embodiment can also be used with a rim configuration described above or with the rim assembly described earlier in this Letters for Patent.

The various devices of the present invention can be used not only for yard and construction debris but also as a recyclable collection system for large event gatherings. In other words, the plastic bag holder can be used to collect recyclables at home or at business functions. This device allows for pre-sorting of plastics and glass and once the bag is filled the device can be wheeled to the curb to dispose of the recyclables on collection day. In the alternative, the filled bag can be wheeled to the car so that it can be placed into a car and taken to a bottle redemption site. All in all, the device can be used for this and many other functions all of which are anticipated by the present invention.

While the invention has been illustrated and described with respect to specific illustrative embodiments and modes of practice, it will be apparent to those skilled in the art that various modifications and improvements may be made without departing from the scope and spirit of the invention. Accordingly, the invention is not to be limited by the illustrative embodiments and modes of practice.

What is claimed is:

1. A trash bag holding and transportation device comprising:
a rim means for holding a bag in an open position;
a clamping means movably attached to said rim means, said clamping means configured for securing said bag to said rim means;
a frame connected to said rim means at one end and a wheel base at the opposite end, said wheel base comprising at least one wheel for transporting said trash bag holding device from one place to the another; and
an anti slip means attached to said rim means for preventing said trash bag holding device from sliding when said rim means is place substantially on a surface.

2. The trash bag holding device of claim 1 wherein said clamping means further comprises a spring strip having a central portion, said central portion configured into a substantially circular shape wherein said spring strip is compressed to permit an open end of a trash bag to be placed thereon, and said spring strip released to cause said open end of said trash bag to be held, said spring strip further comprising a releasable locking means for locking said spring strip in a first position which holds said trash bag to said clamping means and a second position releasing said trash bag from said clamping means.

3. The trash bag holding device of claim 1 wherein said anti slip means comprises at least one foot peg in communication with said trash bag configured for easy entry into a surface so as to prevent said trash bag holding device from moving along the ground as debris is pushed into the open end of said trash bag.

4. The trash bag holding device of claim 3 wherein said anti-slip means is connected to said rim by a hinged means which permits said anti-slip means to fold substantially flat to said rim means in one position and substantially perpendicular to said rigid rim means in a second position.

5. The trash bag holding device of claim 4 wherein said anti slip means are at least partially coated with an anti-slip coating selected from the group consisting of rubber, high friction material, anti-slip paint, anti-slip thermal sprayed powder coating, and mixtures thereof.

6. The trash holding device of claim 3 further comprising a handle movably attached to said rim means, said handle having a first position and a second position and being in communication with said at least one foot peg so that when said handle is in a first position said foot peg is retracted into said rim means and when said handle is moved to said second position said foot peg is moved into an extended position for use.

7. The trash bag holding device of claim 3 wherein said at least one foot peg further comprises a worm-screw type point.

8. The trash bag holding device of claim 6 wherein said handle is connected to said rim means by a hinge means and said first position of said handle is substantially adjacent to a portion of the rim means comprising said anti slip means and said second position is substantially opposite from said portion of said rim means comprising said anti-slip means, whereby when said handle is positioned to upright said trash bag holding device said anti-slip means are in the retracted position.

9. The trash bag holding device of claim 1 wherein said wheelbase comprises two wheels connected to an axle wherein said axle is connected to said frame on the same side of said trash bag holding device as said anti-slip means.

10. The trash bag holding device of claim 1 further comprising a trash bag securing means for securing a trash bag to said frame for transport.

11. The trash bag holding device of claim 10 wherein said trash bag securing means is a flexible strap, a tether strap, a stretchable cord, or a plastic strap.

12. The trash bag holding device of claim 10 wherein said bag securing means comprises at least one substantially rigid arms configured to come in contact with at least a portion of said trash bag when at least partially filled.

13. The trash bag holding device of claim 12 wherein said at least one substantially rigid arm is attached to said frame of said trash bag holding device by a hinged means.

14. The trash bag holding device of claim 1 wherein the rim means comprising a first section and a second section, said first second being attached or attachable to the said trash bag holding device and said second section being configured so as to fit within said first section.

15. The trash bag holding device of claim 14 wherein said rim means further comprises at least one handle in communication with the second section of the rim means and configured so as to not prevent said second section being fit into said first second of said rim means.

16. The trash bag holding device of claim 14 wherein said rim means further comprises spikes configured on one edge of said first section of said rim means device and at least one grip designed to fit over said spikes whereas the grip protects a user from said spike when said spike is not positioned in a surface.

17. The trash bag holding device of claim 16 wherein said at least one grip is attached to said trash bag holding device by an attached means having a memory.

18. The trash bag holding device of claim 17 wherein said attached means having a memory is an elastic string.
